(19) United States
(12) Patent Application Publication
(10) Pub. No.: US 2008/0012369 A1
(43) Pub. Date: Jan. 17, 2008

(54) DEMOLITION SHOVEL

(76) Inventor: Don D. HELTON, Macon, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/776,302

(22) Filed: Jul. 11, 2007

Related U.S. Application Data
(60) Provisional application No. 60/806,995, filed on Jul. 11, 2006.

(51) Int. Cl. A01B 1/02

(52) U.S. Cl. 294/49

(57) ABSTRACT

The present invention is a demolition shovel that includes a handle, a shovel head, and a leverage attachment. The leverage attachment includes an attachment sleeve and leverage sleeve. A user can use the leverage sleeve to leverage force applied to the shovel handle against the shovel head.

### CROSS-REFERENCE TO RELATED APPLICATION

This application claims the benefit of U.S. Provisional Patent Application Ser. No. 60/806,995, filed Jul. 11, 2006, which application is incorporated herein by reference in its entirety for all purposes.

### TECHNICAL FIELD

The present invention relates generally to demolition tools and more particularly to a shovel and shovel attachment for demolition use.

### BACKGROUND OF THE INVENTION

Demolition tools are widely known in the art and include implements such as wrecking bars, crowbars, pry bars and the like. Traditionally, demolition tools grant a user mechanical leverage while the user is attempting to pry or dislodge various types of building materials when tearing apart a particular piece of construction. Often demolition tools are needed to remove flooring materials from the floor joists in homes or buildings and/or roofing materials from the rafters. In such instances, it is difficult for a user utilizing a known demolition tool to find a consistent location to leverage the demolition tool to remove the materials, as there is often no leverage point other than the rafters or joists themselves. Generally, each rafter or joist is spread apart from each other a distance of about 16 or 24 inches, depending on the building codes for a particular location. Because of this span between leverage points, prior art demolition tools lack a reliable and predictable way for leveraging the tool when trying to pry up flooring or roofing materials.

Thus it can be seen that needs exist for improvements to demolition tools that allow a user to easily and reliably pry up roofing and flooring materials from a building when removing these materials in a demolition process. It is to these needs and others that the present invention is directed.

### SUMMARY OF THE INVENTION

In example forms, the present invention relates to a demolition shovel. The demolition shovel includes a handle, a shovel head, and a leverage attachment. The leverage attachment includes an attachment sleeve and leverage sleeve. A user can use the leverage sleeve to leverage force applied to the shovel handle against the shovel head. Optionally, the leverage sleeve includes a leverage bar that extends laterally beyond the sleeve. The leverage bar can also include wheels or rollers at distal ends of the bar. The present invention is advantageous over the prior art because a user has a reliable and predictable pivot point that allows the user to pry up materials from the supporting structure beneath the shovel. Additionally, a user can slide or roll the shovel along the supporting structure to quickly remove the material attached thereto.

In another aspect, the invention relates to a shovel attachment for retrofitting a shovel having a handle and shovel head. The attachment can include an attachment sleeve for receiving the handle therein, and a leverage sleeve for receiving a leverage bar therethrough. The leverage sleeve can be transversely coupled to the attachment sleeve. The leverage bar allows a user of the shovel to pivot the shovel about the leverage bar to apply leverage to the shovel head.

In still another aspect, the invention relates to a demolition tool including a handle and a working tool end coupled to the handle. Additionally, the demolition tool can include a pivot bar for providing a fulcrum about which the handle pivots. Optionally, the pivot bar can include one or more wheels or rollers for rolling the tool along a surface.

In another aspect, the invention relates to an improvement to a shovel having a handle and shovel head coupled to a distal end of the handle. The improvement includes a pivot bar. The handle can pivot about the pivot bar. Optionally, the pivot bar is a rolling pivot bar.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is an overhead view of a demolition shovel according to a first example embodiment of the present invention.

FIG. 2 is a perspective view of the demolition shovel of FIG. 1.

FIG. 3 is a partially exploded side view of the demolition shovel of FIG. 1.

FIG. 4 is a front view of a leverage attachment assembly according to a second example embodiment of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

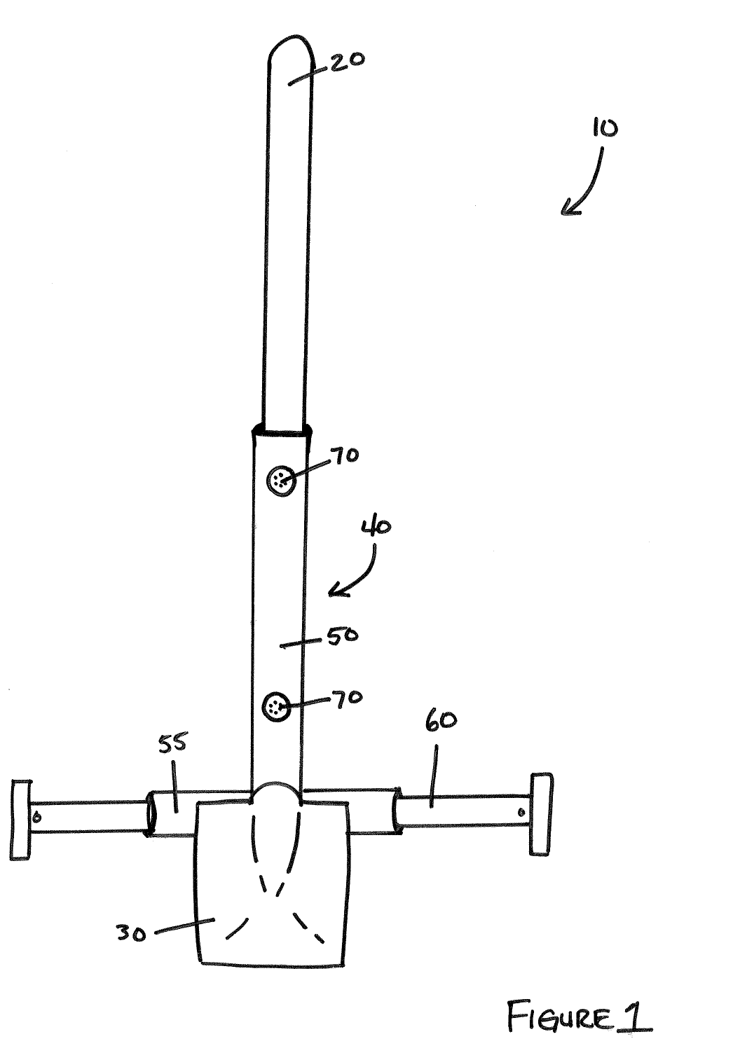

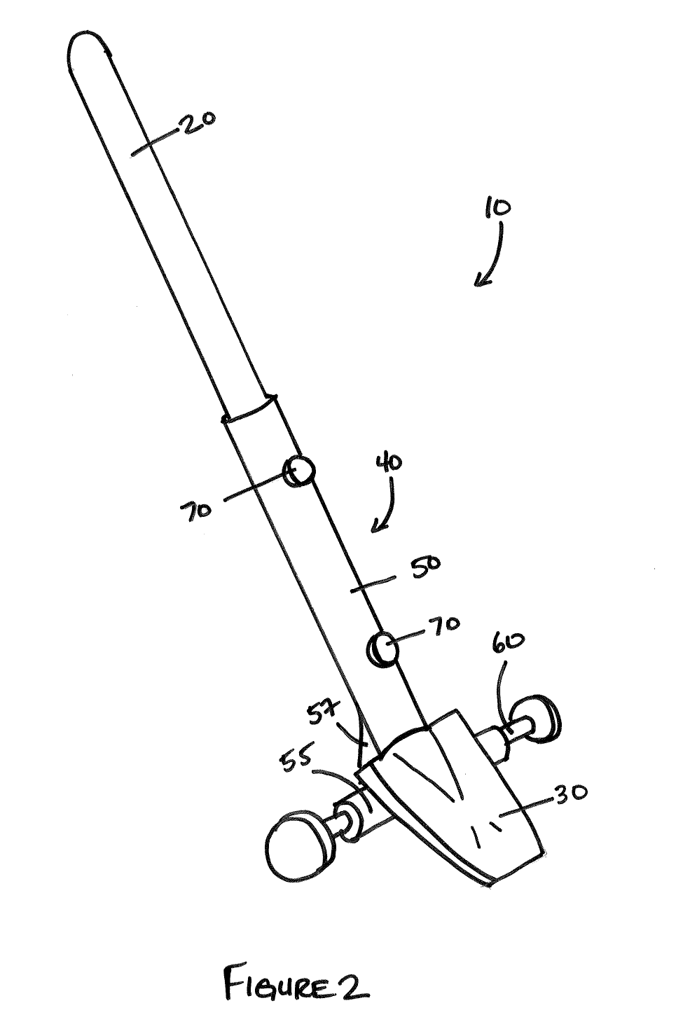

With reference now to the drawing figures, FIGS. 1-3 show a demolition shovel 10 according to an example embodiment of the present invention. The shovel 10 generally comprises a handle 20, shovel head 30, and leverage attachment 40. The leverage attachment 40 can further comprise an attachment sleeve 50 and leverage sleeve 55. The shovel 10 can vary in size depending on the intended use and needs of the user, although preferably the shovel of the present invention is a standard size as known in the art for single person utilization. The shovel head 30 can be any shape or head style presently known in the art, although examples of shovel heads used in commercial embodiments of the present invention include, flat, rounded, spade-like, and pointed. In alternative embodiments, other head styles 30 can be used with the present invention, such as those associated with other tool implements including hoes, picks, crow bars, etc. The handle 20 is preferably constructed of a substantially rigid material such as wood, metal, rigid plastic, rubber, or other materials as desired. However, preferably the handle is formed from wood.

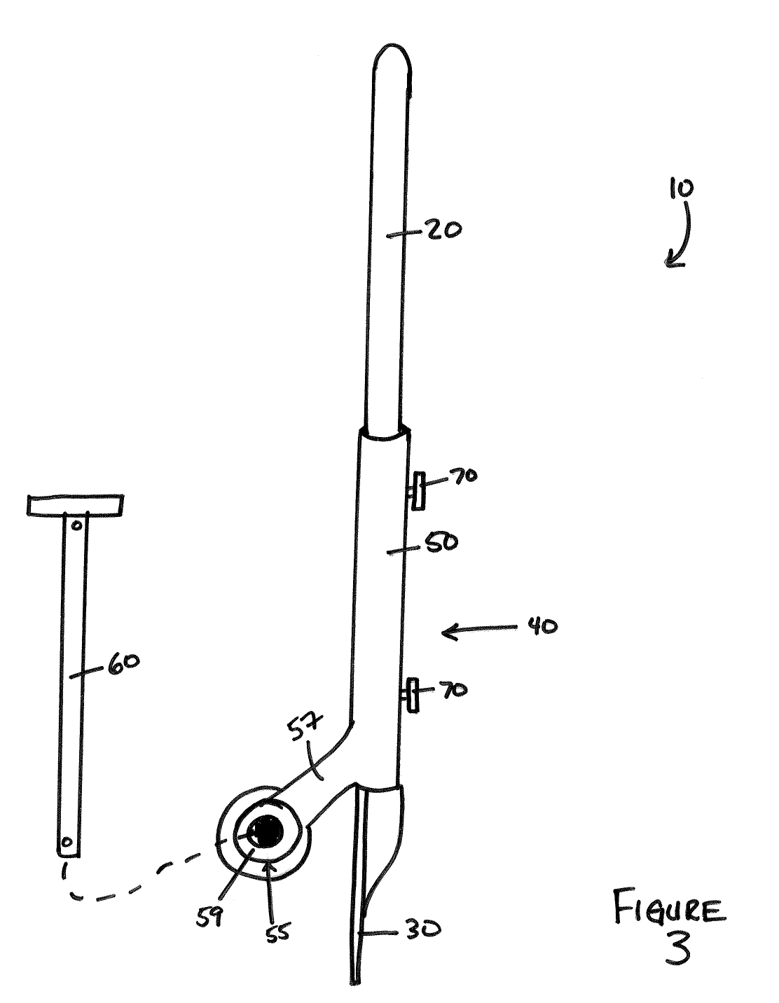

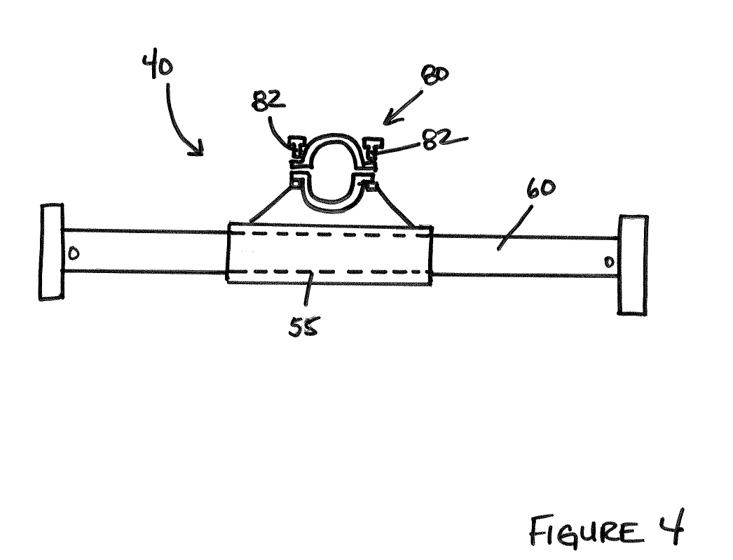

As shown in the drawing figures, the leverage attachment 40 can better be defined as comprising at least two substantially transversely mounted hollow tubular members: the attachment sleeve 50 and the leverage sleeve 55. In example embodiments, the attachment sleeve 50 and leverage sleeve 55 are transversely coupled to each other. The sleeves 50,55 can be secured by weld, bolts, clips, nails, screws, or other known fasteners or fastening techniques. In commercial embodiments, the leverage attachment further comprises a third tubular member 57, as best seen in FIG. 3, which is welded between the attachment sleeve 50 and leverage sleeve 55 to create a greater mechanical advantage for the shovel 10. The attachment sleeve 50 is adapted to slidably receive the handle 20 of the shovel 10 therein, and can be secured to the same with one or more set screws 70. In alternative embodiments, the attachment sleeve 50 can be coupled to the handle 20 with bolts, screws, clips, etc. Alternatively, the handle and sleeve 50 can be integrated. In other example embodiments, the leverage attachment 40 can comprise a split collar 80, as seen in FIG. 4, that fits over the handle 20 of the shovel 10 and utilizes at least one bolt or screw 82 to tightly secure the collar to the handle. The leverage attachment 40 is preferably constructed from steel tubing, but it can be formed from other durable and substantially rigid materials such as, aluminum, iron, other metals, metal alloys, hard plastic, rubber, or other materials as desired. In still other example embodiments, the shovel handle 20, head 30, and leverage attachment 40 can be formed as a unitary piece.

The leverage sleeve 55 is preferably configured to slidably receive a leverage bar 60 therethrough, as shown in the drawing figures. The sleeve 55 can comprise one or more internal bearings 59 (FIG. 3) to support and guide the leverage bar therewithin, such that the bar is free to roll and slide within the sleeve 55. In this manner, the leverage bar 60 serves as a pivot point for the shovel, and permits a user to leverage the shovel head 30 against the bar to create a mechanical advantage. The leverage bar 60 optionally includes two wheels or rollers 65 positioned at distal ends of the bar to permit the leverage bar to serve as a rolling fulcrum for the shovel 10. The wheels 65 can also prevent the leverage bar 60 from sliding out of engagement with the leverage sleeve 55. In other forms, the rounded ends or wheels 65 can be omitted as desired by a user. In alternate embodiments, the leverage bar 60 can be bonded or otherwise affixed to the attachment sleeve 55, such that the bar cannot move in relation to the sleeve 55.

In operation, the leverage attachment 40 can be adjustably secured to the handle 20 of a conventional shovel by sliding the attachment sleeve 50 over the handle and positioning the sleeve as desired by the user. An example sleeve position is depicted in FIGS. 1-3. Once the sleeve 50 has been positioned in the desired location, a user may fasten the sleeve to the handle 20 with at least one setscrew 70, and more preferably, at least two or more setscrews (or other fasteners for securing the same). A user removing flooring or roofing materials can slide or roll the leverage bar 60 along rafters or joists, which typically support the floors or roof of a building. To this end, it is preferable that the leverage bar 60 is at least as long as the distance between adjoining joists, which is typically at least about 16 inches or about 24 inches. To remove materials attached to the joists, a user can insert the shovel head 30 under the material to be removed and push down on the shovel handle 20, leveraging the force applied at the handle to push up on materials to be removed. As previously mentioned, the shovel head 30 can be flat, spaded, pointed, etc. as desired by the user depending on the particular use of the shovel 10 and application. It is preferable that at least the distal ends, or wheels 65, of the leverage bar 60 be in contact with at least two joists, preferably positioning at least one joist on each side of the shovel head 30 to permit the leverage bar to serve as a pivot and leverage point for the shovel 10. The user can slide the leverage bar 60 back and forth within the leverage sleeve 55 to adjust the position of the shovel head 30 in relation to the leverage bar and adjoining joists, such that the shovel head is no longer centered in relation to the same. This is advantageous for a user trying to pry up materials near a joist, because the leverage bar 60 is still permitted to rest on two or more joists, which provides the user with a solid pivot/leverage point. After prying the materials from a particular location along the joists or rafters by the shovel 10, a user can slide or roll the leverage bar 60 towards any additional materials that need to be removed until the user has removed all desired material. A user may then move the shovel 10 to a new pair of joists and begin removing material in the same fashion.

The shovel 10 of the present invention can be produced and sold with the attachment 40 included with the shovel, and/or the leverage attachment can be sold independently as an aftermarket product intended to retrofit known shovels. Additionally, the leverage attachment 40 can be made in many different sizes to accommodate the numerous distances that may exist between support joists. These distances are often regulated by building codes, particular applications, material properties of the joists, etc.

While the invention has been described with reference to preferred and example embodiments, it will be understood by those skilled in the art that a variety of modifications, additions and deletions are within the scope of the invention, as defined by the following claims.

What is claimed is:

1. A demolition shovel, comprising:
a handle;
a shovel head; and
a leverage attachment including an attachment sleeve and leverage sleeve;
wherein the attachment sleeve secures the handle therein, and wherein a user uses the leverage sleeve to leverage force applied at the handle against the shovel head.

2. The demolition shovel of claim 1, wherein the attachment sleeve and leverage sleeve are tubular members.

3. The demolition shovel of claim 1, wherein the attachment sleeve extends substantially transversely from the leverage sleeve.

4. The demolition shovel of claim 3, wherein the attachment sleeve and leverage sleeve are permanently coupled.

5. The demolition shovel of claim 1, wherein the shovel further comprises a leverage bar, wherein the leverage bar is housed in the leverage sleeve.

6. The demolition shovel of claim 5, wherein the leverage sleeve slidably receives the leverage bar therein.

7. The demolition shovel of claim 5, wherein the leverage bar includes one or more wheels or rollers at distal ends thereof.

8. The demolition shovel of claim 7, wherein the leverage bar provides a rolling fulcrum for the shovel.

9. The demolition shovel of claim 1, wherein the leverage attachment is releasably coupled to the handle.

10. The demolition shovel of claim 1, wherein the attachment sleeve further comprises a split collar for securing the sleeve to the shovel handle.

11. A shovel attachment for retrofitting a shovel having a handle and shovel head, the shovel attachment comprising:
an attachment sleeve for receiving the handle therein; and
a leverage sleeve transversely coupled to the attachment sleeve for receiving a leverage bar therethrough;
wherein the leverage bar allows a user of the shovel to pivot the shovel about the leverage bar, thereby applying leverage to the shovel head.

12. The shovel attachment of claim 11, wherein the leverage bar includes one or more wheels or rollers at distal ends of the bar.

13. The shovel attachment of claim 12, wherein the leverage bar provides a rolling fulcrum for the shovel.

14. The shovel attachment of claim 11, wherein the attachment sleeve and leverage sleeve are tubular members.

15. The shovel attachment of claim 14, wherein the attachment sleeve and leverage sleeve are formed from steel tubing.

16. The shovel attachment of claim 11, wherein the attachment sleeve further comprises a split collar for securing the sleeve to the shovel handle.

17. A demolition tool, comprising:
a handle;
a working tool end coupled to the handle; and
a pivot bar for providing a fulcrum about which the handle pivots.

18. The demolition tool of claim 17, wherein the pivot bar includes one or more wheels or rollers for rolling the tool along a surface.

19. An improvement for a shovel of the type having a handle and a shovel head secured to a distal end of the handle, the improvement therein comprising:
a pivot bar, wherein the handle pivots about the pivot bar.

20. The improvement of claim 19, wherein the pivot bar is a rolling pivot bar.
